(19) United States
(12) Patent Application Publication
(10) Pub. No.: US 2025/0180075 A1
(43) Pub. Date: Jun. 5, 2025

(54) Dual Coupling System for Driving Rail Vehicles

(71) Applicant: KWD Kupplungswerk Dresden GmbH, Dresden (DE)

(72) Inventor: Thomas Hähnel, Wilsdruff (DE)

(21) Appl. No.: 18/835,389

(22) PCT Filed: Feb. 9, 2023
(86) PCT No.: PCT/EP2023/053215

§ 371 Date: Aug. 2, 2024

(30) Foreign Application Priority Data
Feb. 10, 2022 (DE) 20 2022 100 767.5

(51) Int. Cl. F16D 3/18; B61C 17/00; F16D 3/78

(52) U.S. Cl. CPC F16D 3/185; B61C 17/00; F16D 3/78; F16D 2300/08

(57) ABSTRACT

The invention relates to a dual coupling system that can be used in rail vehicles, e.g. trains or trams. The object of the invention is to provide a coupling system that allows for reduced installation space with improved support span and improved compensation behaviour with occurring axial and angular misalignments and which can be economically and quickly maintained and set up. A dual coupling system is provided comprising a first coupling unit (1) associated with a drive assembly, a second coupling unit (2) associated with a transmission assembly, and a connecting shaft (8) arranged between the first and second coupling unit. A casing (3) is force-lockingly and/or interlockingly detachably connected to the connecting shaft in a first end region and the second coupling unit is arranged opposite the first coupling unit in a second end region of the connecting shaft and is force-lockingly and/or interlockingly detachably connected to same. The second coupling unit has a coupling element (9) directed towards the first coupling unit, which allows for an arranging and coupling of a transmission assembly in the region of the connecting shaft between the first and second coupling unit (1, 2).

### CROSS REFERENCE TO RELATED APPLICATIONS

This application is the U.S. national stage of International Application No. PCT/EP2023/053215, filed on 2023 Feb. 9. The international application claims the priority of DE 202022100767.5 filed on 2022 Feb. 10; all applications are incorporated by reference herein in their entirety.

### BACKGROUND

The present invention relates to the technical field of drive and transmission technology and relates to a dual coupling system that can be used in rail vehicles, for example trains or streetcars.

Couplings are well known from the prior art. They are used to transmit torques from one shaft to another. Such couplings may for example be rigid or elastic couplings, and/or switchable or non-switchable couplings. Couplings allow a rigid, rotationally rigid, elastic, rotationally elastic and/or movable connection of two shafts, wherein torque shocks and/or angular offsets between the shafts can be compensated by the couplings.

Such couplings are used inter alia in drivetrains of vehicles such as passenger cars, heavy goods vehicles, utility vehicles, buses or rail vehicles. They are arranged in the drive connections between a drive assembly, for example a motor, and a working machine.

Various solutions for the design of couplings are known from the prior art.

EP 1 940 667 B1 has disclosed a cardanic double-jointed coupling for rail vehicles, said coupling having two joint planes and comprising two coupling joints that are connected to one another, for the purposes of transmitting torque by a pinion hollow shaft, via a shaft that is surrounded by the pinion hollow shaft. One joint plane is associated with a coupling joint having a crowned toothing that is capable of angular and axial compensation, and the other joint plane is associated with a rotationally rigid, flexurally elastic coupling joint. The coupling joint having a crowned toothing has an exchangeable sleeve having an internal toothing, and has an exchangeable coupling hub having an associated external toothing, wherein the shaft designed as intermediate shaft is connected in an end region to the exchangeable coupling hub, and wherein the pinion hollow shaft is fastened, outside the exchangeable sleeve, to the outer wall of the sleeve.

DE 10 050 757 A1 has disclosed a drive unit for rail vehicles having a vehicle frame, having a transmission and having a cardanic coupling system, wherein the coupling system is arranged between a wheelset shaft and the transmission. A first part of the coupling system in the form of a curved-tooth gear coupling is integrated into the output tooth gear of the transmission and into the lubricating oil circuit thereof, wherein an output-side second part of the coupling system is provided between transmission and wheelset.

A disadvantage of the solutions known from the prior art is that the proposed coupling systems take up a large structural space but provide a short support span. It is also a disadvantage that known couplings only inadequately compensate angular and axial displacements between drive unit and wheelset and are expensive and time-consuming to service and repair.

### SUMMARY

It is the object of the present invention to specify a coupling system which takes up a small structural space whilst providing an improved support span, allows improved compensation behavior for occurring axial and angular displacements, and can be serviced and repaired inexpensively and quickly.

The object is achieved by the technical features according to claim 1. The subclaims relate to advantageous refinements, wherein the invention also encompasses combinations of the individual dependent claims in the sense of an “and” combination, provided that they are not are mutually exclusive.

### DETAILED DESCRIPTION

The object is achieved by a dual coupling system for the drive of rail vehicles, having a first coupling unit, which is assigned to a drive assembly and compensates axial displacements and angular offsets, having a second coupling unit, which is assigned to a transmission assembly and which compensates angular offsets, and having a connecting shaft, which is arranged between the first and second coupling units and which is formed at least as a single piece, wherein the first coupling unit is connected interlockingly and/or frictionally via a hub to a drive shaft, wherein the hub has a crowned external toothing which meshes with an internal toothing of a sleeve, wherein the sleeve is frictionally and/or interlockingly detachably connected in a first end region to the connecting shaft, and wherein the second coupling unit is arranged opposite the first coupling unit in a second end region of the connecting shaft and is frictionally and/or interlockingly detachably connected to said connecting shaft, wherein the second coupling unit has a coupling element which is directed toward the first coupling unit and which allows a transmission assembly to be arranged and coupled in the region of the connecting shaft between the first and second coupling units.

It is advantageous if the first coupling unit is a tooth coupling, and it is likewise advantageous if the second coupling unit is an annular disk coupling, an annular wedge assembly coupling, a wedge assembly coupling, a plate coupling, a link coupling or a steel multiplate coupling.

In one advantageous refinement of the dual coupling system, a free space is formed between hub and crowned external toothing, wherein a sealing element is particularly advantageously arranged in the free space that is formed.

In one particularly advantageous refinement, the sealing element is arranged in the free space centrally in the region of the tooth central plane of the meshing crowned external toothing. It is furthermore advantageous if the sealing element is an elastic element or corrugated tube that is connected interlockingly, cohesively and/or frictionally to the sleeve and to the hub.

It is advantageous if the sleeve is connected to the first end region of the connecting shaft by a face toothing and/or a flange connection.

It is also advantageous if the second coupling unit is connected to the connecting shaft by a central connecting element.

In one advantageous refinement, the first coupling unit has at least one securing element that is arranged between hub and drive shaft, wherein it is particularly advantageous if the securing element is formed as an overload bushing and is connected to the hub and to the drive shaft by an interference fit.

It is also advantageous if at least one electrical isolation element is provided in the region of the flange connection and/or in the hub.

It is also advantageous if the connecting shaft is an integral part of the second coupling unit, wherein the first end region of the connecting shaft is connected frictionally and/or interlockingly to the first coupling unit via the sleeve and/or to the flange of the flange connection.

With the present solution, an improved dual coupling system for the drive of rail vehicles is provided, which dual coupling system can be assembled, serviced and repaired quickly and inexpensively, takes up a small structural space whilst providing an improved support span, and allows improved compensation behavior for occurring axial and angular displacements.

The technical advantages of the proposed dual coupling system are achieved by virtue of two different coupling units being provided, which are connected by a connecting shaft and which exhibit different compensation behavior with regard to occurring angular and axial offsets. The first coupling unit is assigned to a drive assembly and makes it possible in particular for axial displacements to be compensated. The second coupling unit is assigned to a transmission assembly and is arranged opposite the first coupling unit at the second end of the connecting shaft. The second coupling unit is designed as a coupling which compensates primarily, but not exclusively, occurring angular offsets. As a dual coupling system, said couplings combine the technical advantage whereby, when angular and axial offsets occur, an improved radial compensation capability is also provided.

The first coupling unit has a hub which is arranged interlockingly and/or frictionally on a drive shaft and which has a crowned external toothing for transmitting a torque and for compensating an occurring axial offset.

According to the invention, the crowned external toothing of the first coupling unit meshes with an internal toothing of a sleeve, wherein, for inexpensive and quick installation or dismounting of the first coupling unit, the sleeve is detachably connected to the connecting shaft, which is formed as a single piece or in multiple pieces, via a flange connection.

The particular arrangement of the first coupling unit on the drive side has the technical advantage and synergistic effect that, owing to the small radial extent of the sleeve, the first coupling unit can be at least partially integrated into the structural space of the drive assembly. The structural space of the dual coupling system that is saved as a result of the integration allows a greater support span of the connecting shaft, allowing improved radial compensation behavior between drive assembly and transmission assembly.

According to the invention, the second coupling unit is arranged opposite the first coupling unit at the second end of the connecting shaft and is frictionally and/or interlockingly detachably connected to said connecting shaft. The second coupling unit is assigned to a transmission assembly and is designed as a coupling that compensates angular offsets. Such coupling units may advantageously be an annular disk coupling, an annular wedge assembly coupling, a wedge assembly coupling, a plate coupling or a steel multiplate coupling.

The major advantage of arranging the second coupling unit, which compensates angular offsets, on the transmission side consists in that, owing to the disk-like second coupling unit, an exposed axial overhang adjacent to the transmission assembly, as would arise for example owing to a sleeve of the first coupling unit, is avoided.

According to the invention, for a more compact design and optimum weight distribution, provision is made for the second coupling unit to have a coupling element which is directed toward the first coupling unit and by which the transmission assembly can be coupled in the region of the connecting shaft between the first and second coupling units. The transmission assembly may be coupled to the coupling element via a face toothing, for example.

In one advantageous refinement of the coupling system, provision may be made for a free space to be formed between hub and crowned external toothing.

The free space that is formed allows the advantageous arrangement of a sealing element, which in particular prevents the ingress of undesired contaminants in the region in which the crowned external and internal toothings mesh within the sleeve.

Here, the arrangement of the sealing element in the free space that is formed is such that said sealing element makes sealing contact with the inner wall of the sleeve and with the hub. The sealing element can be easily inserted into the free space and inexpensively and quickly replaced when worn.

It is particularly advantageous if the sealing element is arranged in the region of the tooth central plane of the meshing crowned external toothing.

An arrangement of the sealing element close to the center in the region of the tooth central plane of the meshing crowned external toothing has the synergistic effect that less load is placed on the sealing element when angular offsets arise, resulting in less wear and thus allowing a longer service life of the sealing element. The sealing element may particularly advantageously be an elastic element or a metal bellows in the form of a corrugated tube, which can be fixed in the free space that is formed.

A further major advantage of the sealing element that is arranged in the free space that is formed consists in that a particularly durable and permanent seal is achieved, and lubricant leakage is prevented. Furthermore, the sealing element that is provided allows the use of lubricant of low viscosity, which can furthermore be easily supplied to the hermetically sealed free space.

In a further advantageous refinement, provision may be made for a securing element to be provided between the hub and the drive shaft. Such a securing element may for example be an overload bushing or slipping bushing for preventing overloading and failure of the first coupling unit.

In order to allow electrical decoupling of drive assembly and transmission assembly, an electrical isolator may advantageously be provided. An inexpensive solution for electrical isolation may be achieved here by electrical isolation elements arranged in the connecting region of flange and sleeve. The electrical isolation may be achieved for example by electrically isolating elements that are provided within the flange connection of the frictional connection to the sleeve.

It is alternatively also conceivable for at least one electrical isolation element to be provided in the hub of the first coupling unit. In this case, provision may be made for the hub to be formed in multiple pieces radially, and for the electrical isolation to be arranged between the pieces of the hub as a form of isolation bushing.

A refinement of the dual coupling system that is particularly favorable from a servicing and assembly aspect is obtained if the connecting shaft is advantageously a directly integral part of the second coupling unit.

In the context of the invention, an integral part of the second coupling unit is to be understood to mean that the connecting shaft extends out of the second coupling unit and is a part thereof, without the need for an additional connecting point and/or central connecting element and/or toothing in the region of the second coupling unit.

Numerous technical advantages and synergistic effects are achieved with the dual coupling system according to the invention.

Aside from the advantages of high fatigue strength and stability, a smaller structural space requirement is also made possible.

Owing to the specific arrangement of the first coupling unit having a crowned external toothing, which first coupling unit is assigned to a drive assembly and is for example a tooth coupling, and of the second coupling unit, which is hereinafter assigned to a transmission assembly and is for example a multiplate coupling, a greater support span is provided between drive side and transmission side, which in particular allows significantly improved compensation behavior with regard to angular offsets and axial displacements and consequently also radial offsets of drive assembly and transmission assembly in the dual coupling system.

The invention also allows the individual elements of the dual coupling system as a whole to be easily and freely exchanged without problems, thus reducing the time and costs involved in servicing. Furthermore, the specific design of the first coupling unit makes it possible, with a precisely positioned arrangement of the sealing element in the free space between sleeve and crowned external toothing and particularly advantageously in the region of the tooth central plane of the meshing crowned external toothing, for the service life of the sealing element to be improved, and thus for a reliable and durable sealing system to be provided.

The specific arrangement and assignment of the drive-side first and transmission-side second coupling units offer numerous advantages and alternatives with regard to the design and configuration of the dual coupling system.

The arrangement of the first coupling unit, which compensates angular and axial offsets, on the drive side makes it possible to achieve a much more compact design and thus to save structural space.

It is alternatively possible for the structural space that is saved to be utilized to realize an increased support span, which in turn leads to further improved radial compensation behavior of the dual coupling system. In this respect, the design and configuration of the dual coupling system can be flexibly adapted according to the application.

The invention will be discussed in more detail below on the basis of two exemplary embodiments.

### BRIEF DESCRIPTION OF THE DRAWINGS

FIG. 1 shows a possible design of the dual coupling system in cross section, and

FIG. 2 shows another possible design of the dual coupling system in cross section.

### DETAILED DESCRIPTION OF THE PREFERRED EMBODIMENTS

### Example 1

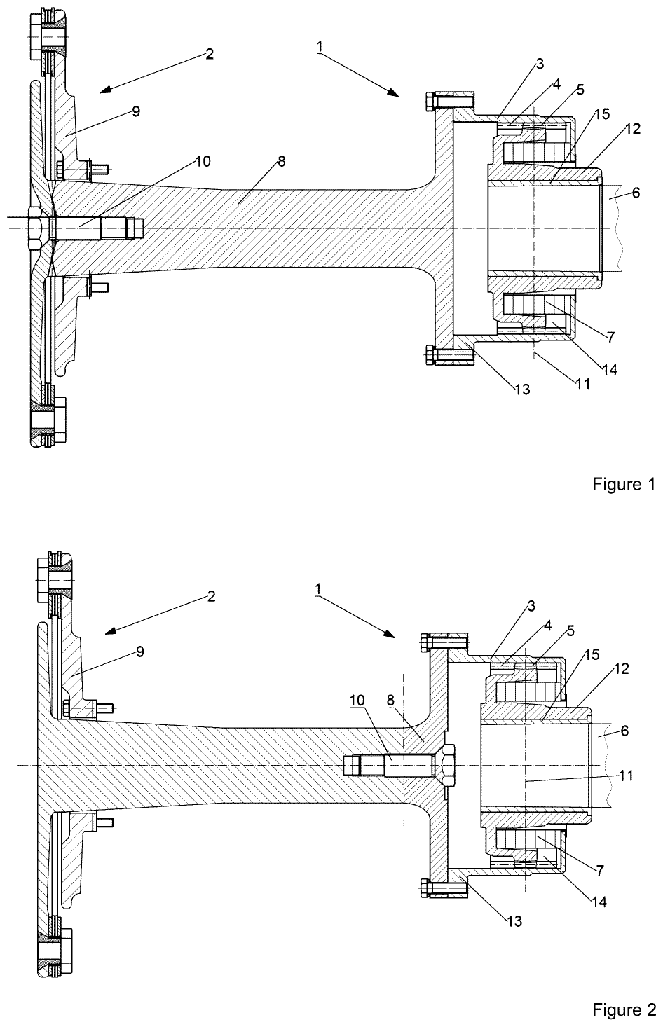

FIG. 1 illustrates a dual coupling system for rail vehicles having two coupling units 1 and 2. The two coupling units 1 and 2 are connected, for the purposes of transmitting torque, to a connecting shaft 8, wherein the first coupling unit 1 is a tooth coupling which is connected, via a hub 12 having a crowned external toothing 5 with angular and axial compensation capability, to the drive shaft 6 via a securing element 15 in the form of a press-fitted overload bushing. The drive shaft 6 is connected to and driven by a motor (not shown).

The crowned external toothing 5 of the first coupling unit 1 meshes with the internal toothing 4 of the exchangeable sleeve 3. The sleeve 3 has an external diameter of 245 mm and is integrated in a motor tunnel of the motor (not shown).

The shaft 8, which is designed as a connecting shaft, is connected on the drive side to the exchangeable first coupling unit 1 via the formed flange connection 13 to the sleeve 3.

A rotationally rigid and flexurally elastic multiplate coupling as a second coupling unit 2 is arranged at the other end of the connecting shaft 8 and is detachably connected to the connecting shaft 8 by a central connecting element 10, which is a central screw.

The multiplate coupling 2 is connected to the coupling element 9, which is directed toward the tooth coupling 1, in stellate fashion by a total of six connecting points, wherein the coupling element 9 is designed such that it can be connected by a face toothing to a transmission assembly that can be arranged around the connecting shaft 8.

The first coupling unit 1 having hub 12 and crowned external toothing 5 is surrounded by the sleeve 3.

In the first coupling unit 1, for the purposes of sealing against an ingress of contaminants, an elastic sealing element 7 is provided, centrally in the region of the tooth central plane 11 of the meshing crowned external toothing 5, in a free space 14 formed between the crowned external toothing 5 and the hub 12, said sealing element being fixed by a strut connection to the sleeve 3 and a screw connection to the hub 12 in the region of the free space 14.

The dual coupling system, as shown in FIG. 1, can be used in a rail vehicle and the tooth coupling 1 allows improved axial displacement behavior and the multiplate coupling 2 allows improved angular compensation behavior and simultaneous radial compensation behavior whilst providing an increased support span.

### Example 2

FIG. 2 illustrates a further possible design of the dual coupling system for rail vehicles having two coupling units 1 and 2. The two coupling units 1 and 2 are connected, for the purposes of transmitting torque, to a connecting shaft 8, wherein the first coupling unit 1 is a tooth coupling which is connected, via a hub 12 having a crowned external toothing 5 with angular and axial compensation capability, to the drive shaft 6 via a securing element 15 in the form of a press-fitted overload bushing. The drive shaft 6 is connected to and driven by a motor (not shown).

The crowned external toothing 5 of the first coupling unit 1 meshes with the internal toothing 4 of the exchangeable sleeve 3. The sleeve 3 has an external diameter of 245 mm and is integrated in a motor tunnel of the motor (not shown).

The multiplate coupling 2 is connected to the coupling element 9, which is directed toward the tooth coupling 1, in stellate fashion by a total of six connecting points, wherein the coupling element 9 is designed to be connected to a face toothing to a transmission assembly that can be arranged around the connecting shaft 8.

The connecting shaft 8 is formed as an integral part of the second coupling unit 8 and extends directly from the second coupling unit 2, in the direction of the first coupling unit 1, directly to the flange connection 13.

The first coupling unit 1 having hub 12 and crowned external toothing 5 is surrounded by the sleeve 3.

In the first coupling unit 1, for the purposes of sealing against an ingress of contaminants, an elastic sealing element 7 is provided, centrally in the region of the tooth central plane 11 of the meshing crowned external toothing 5, in a free space 14 formed between the crowned external toothing 5 and the hub 12, said sealing element being fixed by a strut connection to the sleeve 3 and a screw connection to the hub 12 in the region of the free space 14.

Owing to the fact that the connecting shaft 8 is an integral part of the second coupling unit 2, an additional connecting point between the second end region of the connecting shaft 8 and the second coupling unit 2, with a central connecting element 10, can be omitted.

The dual coupling system, as shown in FIG. 2, can be used in a rail vehicle and the tooth coupling 1 allows improved axial displacement behavior and the multiplate coupling 2 allows improved angular compensation behavior and simultaneous radial compensation behavior whilst providing an increased support span.

### LIST OF REFERENCE NUMERALS

1—First coupling unit
2—Second coupling unit
3—Sleeve
4—Internal toothing
5—Crowned external toothing
6—Drive shaft
7—Sealing element
8—Connecting shaft
9—Coupling element
10—Central connecting element
11—Tooth central plane
12—Hub
13—Flange connection
14—Free space
15—Securing element

1. A dual coupling system for the drive of rail vehicles, having a first coupling unit (1), which is assigned to a drive assembly and compensates axial displacements and angular offsets, having a second coupling unit (2), which is assigned to a transmission assembly and which compensates angular offsets, and having a connecting shaft (8), which is arranged between the first and second coupling units (1, 2) and which is formed at least as a single piece, wherein the first coupling unit (1) is connected interlockingly and/or frictionally via a hub (12) to a drive shaft (6), wherein the hub (12) has a crowned external toothing (5) which meshes with an internal toothing (4) of a sleeve (3), wherein the sleeve (3) is frictionally and/or interlockingly detachably connected in a first end region to the connecting shaft (8), and wherein the second coupling unit (2) is arranged opposite the first coupling unit (1) in a second end region of the connecting shaft (8) and is frictionally and/or interlockingly detachably connected to said connecting shaft, wherein the second coupling unit (2) has a coupling element (9) which is directed toward the first coupling unit (1) and which allows a transmission assembly to be arranged and coupled in the region of the connecting shaft (8) between the first and second coupling units (1, 2).

2. The dual coupling system as claimed in claim 1, in which the first coupling unit (1) is a tooth coupling.

3. The dual coupling system as claimed in claim 1, in which the second coupling unit (2) is an annular disk coupling, an annular wedge assembly coupling, a wedge assembly coupling, a plate coupling, a link coupling or a steel multiplate coupling.

4. The dual coupling system as claimed in claim 1, in which a free space (14) is formed between hub (12) and crowned external toothing (5).

5. The dual coupling system as claimed in claim 4, in which a sealing element (7) is arranged in the free space (14) that is formed.

6. The dual coupling system as claimed in claim 5, in which the sealing element (7) is arranged in the free space (14) centrally in the region of the tooth central plane (11) of the meshing crowned external toothing (5).

7. The dual coupling system as claimed in claim 5, in which the sealing element (7) is an elastic element or corrugated tube that is connected interlockingly, cohesively and/or frictionally to the sleeve (3) and to the hub (12).

8. The dual coupling system as claimed in claim 1, in which the sleeve (3) is connected to the first end region of the connecting shaft (8) by a face toothing and/or a flange connection (13).

9. The dual coupling system as claimed in claim 1, in which the second coupling unit (2) is connected to the connecting shaft (8) by a central connecting element (10).

10. The dual coupling system as claimed in claim 1, in which the first coupling unit (1) has at least one securing element (15) that is arranged between hub (12) and drive shaft (6).

11. The dual coupling system as claimed in claim 10, in which the securing element (15) is formed as an overload bushing and is connected to the hub (12) and to the drive shaft (6) by an interference fit.

12. The dual coupling system as claimed in claim 1, in which at least one electrical isolation element is provided in the region of the flange connection (13) and/or in the hub (12).

13. The dual coupling system as claimed in claim 1, in which the connecting shaft (8) is an integral part of the second coupling unit (2), wherein the first end region of the connecting shaft (8) is connected frictionally and/or interlockingly to the first coupling unit (1) via the sleeve (3) and/or to the flange of the flange connection (13).
